(19) United States
(12) Patent Application Publication
(10) Pub. No.: US 2026/0193457 A1
(43) Pub. Date: Jul. 9, 2026

(54) RUBBER COMPOSITIONS AND ARTICLES THEREOF

(71) Applicant: The Goodyear Tire & Rubber Company, Akron, OH (US)

(72) Inventors: Ryan Christopher Scott Jones, Massillon, OH (US); Andreas Frantzen, Trier (DE); Joseph John Kulig, Tallmadge, OH (US); Duane Thomas Delaney, Canton, OH (US)

(21) Appl. No.: 19/013,306

(22) Filed: Jan. 8, 2025

(51) Int. Cl. C08L 23/22; B29C 73/16; B29K 7/00; B29K 9/00; B29K 23/00; C08K 3/04; C08K 3/06; C08K 3/22; C08K 5/31; C08K 5/38; C08K 5/39

(52) U.S. Cl. CPC C08L 23/22; B29C 73/163; C08K 3/04; C08K 3/06; C08K 5/31; C08K 5/38; C08K 5/39; B29K 2007/00; B29K 2009/00; B29K 2023/22; C08K 2003/2296; C08L 2205/02; C08L 2312/02

(57) ABSTRACT

In one aspect, the disclosure relates a composition, comprising at least a first phase and a second phase, where: the first phase comprises from about 10 phr to about 25 phr of a natural rubber, polyisoprene, or a combination thereof; the second phase comprises from about 75 phr to about 90 phr of a synthetic elastomer; and both the first phase and the second phase together comprise from about 200 phr to about 500 phr of a diluent. Also disclosed herein are vulcanized or cured compositions and articles, such as tires, comprising said vulcanized or cured compositions. This abstract is intended as a scanning tool for purposes of searching in the particular art and is not intended to be limiting of the present disclosure.

### BACKGROUND

The demand for improved tire performance has resulted in the development and evaluation of new materials that have desirable properties. One area of tire production that is currently lacking is methods and materials used to produce a sealant layer on a tire post-cure. Tires with sealant layers applied can suffer from various problems, such as the sealant layer having a negative impact on tire performance after application. For example, current tire sealants can exhibit cold flow, which can cause a tire with a sealant layer to become unbalanced over time. Ideally, tire sealants will have little to no detrimental impact on tire performance, including mechanical properties such as rolling resistance and uniformity. Additionally, in order to produce more environmentally sustainable tires and tire components, there is an interest in using less petroleum-derived raw materials in tire production. Thus, there is a need for more environmentally sustainable tire sealant compositions that have a good balance between firmness, lessening cold flow, and malleability, allowing for effective sealing of tire punctures. These needs and other needs are satisfied by the present disclosure.

### SUMMARY

In accordance with the purpose(s) of the disclosure, as embodied and broadly described herein, the disclosure, in one aspect, relates to a composition, comprising at least a first phase and a second phase, where: the first phase comprises from about 10 phr to about 25 phr of a natural rubber, polyisoprene, or a combination thereof; the second phase comprises from about 75 phr to about 90 phr of a synthetic elastomer; and both the first phase and the second phase together comprise from about 200 phr to about 500 phr of a diluent. Also disclosed herein are vulcanized or cured compositions and articles, such as tires, comprising said vulcanized compositions.

Other systems, methods, features, and advantages of the present disclosure will be or become apparent to one with skill in the art upon examination of the following detailed description. It is intended that all such additional systems, methods, features, and advantages be included within this description, be within the scope of the present disclosure, and be protected by the accompanying claims. In addition, all optional and preferred features and modifications of the described aspects are usable in all aspects of the disclosure taught herein. Furthermore, the individual features of the dependent claims, as well as all optional and preferred features and modifications of the described aspects are combinable and interchangeable with one another.

### BRIEF DESCRIPTION OF THE FIGURES

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 shows a representative plot of cure testing performed at 100° C. for various rubber compositions, in accordance with various embodiments of the present disclosure.

FIG. 2 shows a representative Van Gurp-Palmen plot showing rheological properties for various rubber compositions, in accordance with various embodiments of the present disclosure.

Additional advantages of the disclosure will be set forth in part in the description which follows, and in part will be obvious from the description, or can be learned by practice of the disclosure. The advantages of the disclosure will be realized and attained by means of the elements and combinations particularly pointed out in the appended claims. It is to be understood that both the foregoing general description and the following detailed description are exemplary and explanatory only and are not restrictive of the disclosure, as claimed.

### DETAILED DESCRIPTION

Many modifications and other aspects disclosed herein will come to mind to one skilled in the art to which the disclosed compositions and methods pertain having the benefit of the teachings presented in the foregoing descriptions. Therefore, it is to be understood that the disclosures are not to be limited to the specific aspects disclosed and that modifications and other aspects are intended to be included within the scope of the appended claims. The skilled artisan will recognize many variants and adaptations of the aspects described herein. These variants and adaptations are intended to be included in the teachings of this disclosure and to be encompassed by the claims herein.

As will be apparent to those of skill in the art upon reading this disclosure, each of the individual aspects described and illustrated herein has discrete components and features which may be readily separated from or combined with the features of any of the other several aspects without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present disclosure is not entitled to antedate such publication by virtue of prior disclosure. Further, the dates of publication provided herein can be different from the actual publication dates, which can require independent confirmation.

While aspects of the present disclosure can be described and claimed in a particular statutory class, such as the composition statutory class, this is for convenience only and one of skill in the art will understand that each aspect of the present disclosure can be described and claimed in any statutory class.

Although specific terms are employed herein, they are used in a generic and descriptive sense only and not for purposes of limitation. It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### A. Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used herein, the term “and/or” includes any and all combinations of one or more of the associated listed items. Expressions such as “at least one of,” when preceding a list of elements, modify the entire list and do not modify the individual elements of the list.

As used herein, nomenclature for compounds, including organic compounds, can be given using common names, IUPAC, IUBMB, or CAS recommendations for nomenclature. When one or more stereochemical features are present, Cahn-Ingold-Prelog rules for stereochemistry can be employed to designate stereochemical priority, E/Z specification, and the like. One of skill in the art can readily ascertain the structure of a compound if given a name, either by systemic reduction of the compound structure using naming conventions, or by commercially available software, such as CHEMDRAW™ (Cambridgesoft Corporation, U.S.A.).

As used in the specification and the appended claims, the singular forms “a,” “an” and “the” include plural referents unless the context clearly dictates otherwise. Thus, for example, reference to “an elastomer,” “an oil,” or “a dispersing agent,” includes, but is not limited to, two or more such elastomers, oils, or dispersing agents, and the like. Reference to “a” chemical compound refers to one or more molecules of the chemical compound rather than being limited to a single molecule of the chemical compound. Furthermore, the one or more molecules may or may not be identical, so long as they fall under the category of the chemical compound. Thus, for example, “a” chemical compound is interpreted to include one or more molecules of the chemical compound, where the molecules may or may not be identical (e.g., different isotopic ratios, enantiomers, and the like).

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the terms “optional” or “optionally” means that the subsequently described event or circumstance can or cannot occur, and that the description includes instances where said event or circumstance occurs and instances where it does not.

The terms “rubber” and “elastomer” may be used herein interchangeably, unless indicated otherwise.

As used herein, the term “phr” refers to parts by weight of a respective material per 100 parts by weight of rubber or elastomer. In general, using this convention, an elastomer composition is comprised of 100 parts by weight of rubber/elastomer. The claimed composition may comprise other rubbers/elastomers than explicitly mentioned in the claims, provided that the phr value of the claimed rubbers/elastomers is in accordance with claimed phr ranges and the amount of all rubbers/elastomers in the composition results in total in 100 parts of rubber/elastomer.

As used herein, the term “uncured composition” refers to a composition including at least one natural or synthetic rubber component and, optionally, one or more fillers, processing aids, or additional compounds, that has not been vulcanized. Uncured rubber is sensitive to changes in temperature and has a tendency to undergo “cold flow” (slow movement or deformation under stress) over time. In one aspect, the uncured rubber composition is a masterbatch.

As used herein, the term “vulcanized composition” or “cured composition” refers to a rubber composition obtained by taking an uncured composition as described herein and curing or vulcanizing it, often accomplished using sulfur compounds and/or other curing additives and in the presence of heat. Vulcanized or cured rubber compositions do not undergo cold flow and are less sensitive to changes in temperature relative to uncured rubber compositions. In one aspect, rubber compositions can be cured in molds in order to form finished articles such as tires.

As used herein, the term “repeat unit” as referenced in the elastomers described herein are derived from monomers used to produce the partially saturated elastomers. For example, polybutadiene has the repeat unit as provided below.

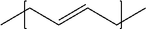

In certain aspects, when the elastomer is the polymerization product of two different monomers (e.g., A and B), the repeat unit can be represented by A-B—.

As used herein, a “residue” of a chemical species refers to the moiety that is the resulting product of the chemical species in a particular reaction scheme or subsequent formulation or chemical product, regardless of whether the moiety is actually obtained from the chemical species. Thus, an isoprene residue in an elastomer refers to one or more —CH₂CH═C(CH₃)CH₂— units in the elastomer, regardless of whether isoprene was used to prepare the elastomer. Similarly, a butadiene residue in an elastomer refers to one or more —CH₂CH═CHCH₂— moieties in the elastomer, regardless of whether the residue is obtained by reacting sebacic acid or an ester thereof to obtain the polyester.

Unless otherwise specified, temperatures referred to herein are based on atmospheric pressure (i.e. one atmosphere).

### B. Rubber Compositions

In one aspect, the disclosure relates to compositions, such as uncured or cured rubber compositions, comprising at least a first phase and a second phase, where the first phase comprises from about 10 phr to about 25 phr of a natural rubber, polyisoprene, or a combination thereof; the second phase comprises from about 75 phr to about 90 phr of a synthetic elastomer; and both the first phase and the second phase together comprise from about 200 phr to about 500 phr of a diluent. The first phase can be a continuous phase. The second phase can be a dispersed phase. In a further aspect, the first phase can include from about 10 phr to about 25 phr, about 15 phr to about 25 phr, about 20 phr to about 25 phr, about 10 phr to about 20 phr, or about 10 phr to about 15 phr of a natural rubber, polyisoprene, or a combination thereof.

In a further aspect, the first phase can further include from about 1 phr to about 10 phr, about 1 phr to about 8 phr about 1 phr to about 5 phr, about 5 phr to about 10 phr, about 1 phr to about 4 phr, about 4 phr to about 8 phr, about 2 phr to about 7 phr, or about 3 phr to about 6 phr of a first resin. In one aspect, the first resin is a tackifier resin. In a further aspect, the second phase can further include from about 1 phr to about 10 phr, about 1 phr to about 8 phr about 1 phr to about 5 phr, about 5 phr to about 10 phr, about 1 phr to about 4 phr, about 4 phr to about 8 phr, about 2 phr to about 7 phr, or about 3 phr to about 6 phr of a second resin. In one aspect, the second resin is a tackifier resin.

The first resin and/or the second resin can be a hydrocarbon resin. The hydrocarbon resins can be an aromatic or nonaromatic resin. The hydrocarbon resins can also have various degrees of unsaturation or be fully saturated. In one aspect, the resins can be derived from C5 alkenes, C7 alkenes, and/or C9 alkenes. In another aspect, the hydrocarbon resin can be a terpene resin (e.g., a terpene polymer) derived from monomer terpene units such as limonene, α-pinene, β-pinene, and/or the like. In a further aspect, the first resin and the second resin can individually be a hydrocarbon resin selected from C5 aliphatic resins, C9 aromatic resins, C7 epoxy resins, terpene resins, and any combination thereof. For example, the hydrocarbon resin can be a C5 aliphatic/C9 aromatic resin.

In a further aspect, the first phase and the second phase together can include from about 200 phr to about 500 phr, about 200 phr to about 450 phr, about 200 phr to about 400 phr, about 200 phr to about 350 phr, about 200 phr to about 300 phr, about 250 phr to about 500 phr, about 300 phr to about 500 phr, about 350 phr to about 500 phr, about 400 phr to about 500 phr, about 250 phr to about 450 phr, about 300 phr to about 400 phr, about 250 phr to about 400 phr, or about 300 phr to about 450 phr of a diluent. The diluent can be selected from polyisobutene, an oil (e.g., aromatic, naphthenic, paraffinic), or a combination thereof. In one aspect, the diluent includes a naphthenic oil.

In a further aspect, the second phase can include from about 75 phr to about 90 phr, about 75 phr to about 85 phr, about 75 phr to about 80 phr, about 80 phr to about 90 phr, or about 85 phr to about 90 phr of the synthetic elastomer. The synthetic elastomer can comprise repeat units formed by residues of isobutene and a conjugated diene (e.g., C4 to C14 conjugated dienes). The synthetic elastomer can be a halogenated rubber. Halogenated rubbers can include chlorinated and brominated rubbers. In one aspect, the synthetic elastomer includes brominated copolymers of isobutene with conjugated dienes and optionally other co-polymerizable monomers. The synthetic elastomer can include repeat units of isobutene in an amount of about 85 wt % to about 99.5 wt %, about 90 wt % to about 99.5 wt %, or about 95 wt % to about 99.5 wt %. The synthetic elastomer can also include repeat units of a conjugated diene in an amount of about 0.5 wt % to about 15 wt %, about 0.5 wt % to about 10 wt %, or about 0.5 wt % to about 5 wt %. In a further aspect, the conjugated diene is a C4 to C8 conjugated diene. In another aspect, the conjugated diene is selected from isoprene, butadiene, hexadiene, or a combination thereof. The synthetic elastomer can be an isoprene-isobutene rubber, a halogenated isoprene-isobutene rubber, or a combination thereof. The synthetic elastomers generally having a number average molecular weight (Mₙ) between 100,000 Da and 500,000 Da. Molecular weight Mₙ may be determined by methods known in the art, such as by gel permeation chromatography following ASTM D3536 or equivalent.

In a further aspect, the first phase and second phase together can also include an accelerator. Accelerators can be preferably but not necessarily used to control the time and/or temperature required for vulcanization/cure and to improve the properties of a vulcanized/cured composition. The accelerator can include from about 1 phr to about 5 phr, about 1 phr to about 4 phr, about 1 phr to about 3 phr, about 2 phr to about 5 phr, or about 2 phr to about 4 phr of zinc isopropylxanthate. The accelerator can further include from about 0.1 phr to about 8.0 phr, about 0.5 phr to about 8.0 phr, about 0.5 phr to about 5.0 phr, about 0.5 phr to about 3.0 phr, about 1.0 phr to about 5.0 phr, or about 1.0 phr to about 3.0 phr of an additional accelerator (also referred to as a co-accelerator) The additional accelerator can be selected from an amine, an imine, a sulfenamide, a guanidine, a dithiocarbamate, a thiadiazole, a thiazole, a thiourea, a thiuram, a dithiophosphate, a xanthate, and any combination thereof. In a further aspect, the additional accelerator can also be selected from cyclohexylethylamine; hexamethylene tetramine; ethyldiene aniline; butyraldehyde dianiline condensate; N-cyclohexyl-2-benzothiazolesulfenamide; N-tertbutyl-2-benzothiazolesulfenamide; N,N-dicyclohexyl-2-benzothiazolesulfenamide; 2-(2-4′dinitrophenylmercapto) benzothiazole; diphenylguanidine (DPG); 1,3-di-o-tolylguanidine; triphenylguanidine; Zinc diethyl dithiocarbamate; zinc N-dibutyl dithiocarbamate; zinc N-ethyl-N-phenyl dithiocarbamate; zinc dibenzyldithiocarbamate (ZBEC); N-cyclohexyl-S-(1,3,4-thiadiazol-2-yl)thiohydroxylamine; 2-mercaptobenzothiazole; 2,2′-dithiobenzothiazole; zinc 2-mercaptobenzothiazole; 2-(morpholinothio) benzothiazole; ethylenethiourea; N—N′-diphenylthiourea; tetramethylthiuram disulfide; tetraethylthiuram disulfide; tetramethylthiuram monosulfide; dipentamethylenethiuram tetrasulfide; zinc dithiophosphate; zinc butylxanthate; sodium isopropyl xanthate; and any combination thereof.

The compositions disclosed herein can include additional components. In one aspect, the additional components can include curing agents, curing aids, such as activators, retarders, and additional accelerators; zinc oxide; and antidegradants, such as antioxidants and antiozonants. The additional components can be present in only the first phase, only the second phases, or in both the first phase and the second phase. A curing agent can be present in an amount of about 0.1 phr to about 8.0 phr, about 0.5 phr to about 5.0 phr, about 0.5 phr to about 5.0 phr, about 0.5 phr to about 3.0 phr, about 1.0 phr to about 3.0 phr, about 1.0 phr to about 2.0 phr, about 2.0 phr to about 5.0 phr, or about 3.0 phr to about 5.0 phr. Activators can include MgO, CaO, polyethylene glycol (PEG, e.g., PEG400 or PEG8000), or combinations thereof. Activators can be included in amounts of about 0.1 phr to about 8.0 phr, about 0.5 phr to about 6.0 phr, or about 0.5 phr to about 4.0 phr. Zinc oxide can be included in amounts of about 1 phr to about 5 phr, about 1 phr to about 3 phr, or about 2 phr to about 5 phr. Antidegradants can be included in amounts of about 1 phr to about 10 phr, about 1 phr to about 5 phr, or about 5 phr to about 10 phr.

### C. Preparation and Applications of Rubber Compositions

The compositions disclosed herein can be compounded by methods generally known in the rubber compounding art, such as mixing the elastomers, diluents, and, optionally, various commonly used additive materials such as: curing or vulcanizing agents, such as sulfur donors; curing aids, such as activators, accelerators, and retarders; processing additives, such as oils, resins (including tackifiers), and plasticizers; fillers, such as carbon black and silica; pigments; fatty acids; zinc oxide; waxes; antidegradants, such as antioxidants and antiozonants; and peptizing agents. Depending on the intended use of the vulcanizable and vulcanized material (rubbers), the additives mentioned above are selected and commonly used in conventional amounts. Activators can include MgO, CaO, polyethylene glycol, or combinations thereof. In another aspect, processing additives can be included in total amounts of about 1 phr to about 50 phr. In one aspect, zinc oxide can be included in the rubber compositions in amounts of about 1 phr to about 5 phr. In another aspect, antidegradants can be included in amounts of about 1 phr to about 10 phr. Representative antioxidants include, but are not limited to, phenylene diamine-based antioxidants (e.g., diphenyl-p-phenylenediamine), dihydroquinolines, and others, such as those disclosed in The Vanderbilt Rubber Handbook (1978), Pages 344 through 346. In one aspect, antiozonants are included in amounts of about 1 phr to about 15 phr. Representative antiozonants include, but are not limited to, N-phenyl-N′-(1,3-dimethylbutyl)-p-phenylenediamine (6PPD) and N,N′-dixylene-p-phenylenediamine (DTPD). In one aspect, fatty acids are included in amounts of about 0.5 phr to about 3 phr. Examples of fatty acids include, but are not limited to, stearic acid, palmitic acids, oleic acid, and mixtures thereof. In one aspect, waxes are included in amounts of about 1 phr to about 5 phr. Microcrystalline waxes, paraffinic waxes, and combinations thereof can be used. In another aspect, activators and retarders, can be included in amounts of about 0.1 phr to about 8.0 phr.

The compositions disclosed herein can be mixed by methods known in the rubber mixing art. In one aspect, the components of the first phase can be mixed in a first step to produce a masterbatch (a mixture comprising rubber and at least one additional component). Following the production of the masterbatch, the components of the second phase can be added to the masterbatch in a continuous mixing step to produce a final mixture. The mixing steps can comprise thermomechanical mixing, generally characterized by mechanical working in a mixer (e.g., internal batch mixer) or extruder for a period of time at an elevated temperature suitable to produce a rubber. The appropriate duration of the thermomechanical mixing varies as a function of the operating conditions and the volume and nature of the components. Following its production, the final mixture can be applied to a tire (post-cure tire). Once applied, a cure step can be performed at a relatively low temperature (e.g., less than 120° C.). In one aspect, the final mixture is applied to a radially inner surface of the tire, such as the innerliner.

This disclosure also provides for articles that incorporate any of the compositions disclosed herein, including cured or vulcanized forms of the compositions disclosed herein. In one aspect, the article comprises a tire, such as a pneumatic tire, or a component of a tire. The tire can be a race tire, passenger tire, aircraft tire, agricultural tire, off-the-road tire, truck or bus tire, and the like. The tire can also be a radial or bias. The component of the tire can be a sealant layer. The sealant layer can be located on a radially inner surface of the tire.

### D. Aspects

The following listing of exemplary aspects supports and is supported by the disclosure provided herein.

Aspect 1. A composition, comprising at least a first phase and a second phase, wherein the first phase comprises from about 10 phr to about 25 phr of a natural rubber, polyisoprene, or a combination thereof; the second phase comprises from about 75 phr to about 90 phr of a synthetic elastomer; and both the first phase and the second phase together comprise from about 200 phr to about 500 phr of a diluent.

Aspect 2. The composition of aspect 1, wherein the first phase further comprises from about 1 phr to about 8 phr of a first resin.

Aspect 3. The composition of aspect 2, wherein the first resin is a hydrocarbon resin selected from the group consisting of C5 aliphatic resins, C9 aromatic resins, C7 epoxy resins, terpene resins, and a combination thereof.

Aspect 4. The composition of any one of aspects 1-3, wherein the second phase further comprises from about 1 phr to about 8 phr of a second resin.

Aspect 5. The composition of aspect 4, wherein the second resin is a hydrocarbon resin selected from C5 aliphatic resins, C9 aromatic resins, C7 epoxy resins, terpene resins, and a combination thereof.

Aspect 6. The composition of any one of aspects 1-5, wherein the diluent is selected from a polyisobutene, a naphthenic oil, or a combination thereof.

Aspect 7. The composition of any one of aspects 1-6, wherein the first phase comprises from about 15 phr to about 25 phr of the natural rubber, polyisoprene, or combination thereof.

Aspect 8. The composition of any one of aspects 1-7, wherein the second phase comprises from about 75 phr to about 85 phr of the synthetic elastomer.

Aspect 9. The composition of any one of aspects 1-8, wherein both the first phase and the second phase together further comprise an accelerator.

Aspect 10. The composition of aspect 9, wherein the accelerator comprises zinc isopropylxanthate.

Aspect 11. The composition of aspect 10, wherein the accelerator comprises from about 1 phr to about 3 phr of zinc isopropylxanthate.

Aspect 12. The composition of aspect 10 or aspect 11, wherein the composition further comprises an additional accelerator selected from the group consisting of an amine, an imine, a sulfenamide, a guanidine, a dithiocarbamate, a thiadiazole, a thiazole, a thiourea, a thiuram, a dithiophosphate, a xanthate, and a combination thereof.

Aspect 13. The composition of any one of aspects 10-12, wherein the composition further comprises an additional accelerator selected from the group consisting of cyclohexylethylamine; hexamethylene tetramine; ethyldiene aniline; butyraldehyde dianiline condensate; N-cyclohexyl-2-benzothiazolesulfenamide; N-tertbutyl-2-benzothiazolesulfenamide; N,N-dicyclohexyl-2-benzothiazolesulfenamide; 2-(2-4′dinitrophenylmercapto) benzothiazole; diphenylguanidine; 1,3-di-o-tolylguanidine; triphenylguanidine; Zinc diethyl dithiocarbamate; zinc N-dibutyl dithiocarbamate; zinc N-ethyl-N-phenyl dithiocarbamate; zinc dibenzyldithiocarbamate; N-cyclohexyl-S-(1,3,4-thiadiazol-2-yl)thiohydroxylamine; 2-mercaptobenzothiazole; 2,2′-dithiobenzothiazole; zinc 2-mercaptobenzothiazole; 2-(morpholinothio) benzothiazole; ethylenethiourea; N—N′-diphenylthiourea; tetramethylthiuram disulfide; tetraethylthiuram disulfide; tetramethylthiuram monosulfide; dipentamethylenethiuram tetrasulfide; zinc dithiophosphate; zinc butylxanthate; sodium isopropyl xanthate; and a combination thereof.

Aspect 14. The composition of aspect 12 or aspect 13, wherein the composition further comprises from about 1 phr to about 3 phr of the additional accelerator.

Aspect 15. The composition of any one of aspects 1-14, wherein the first phase is a continuous phase.

Aspect 16. The composition of any one of aspects 1-15, wherein the second phase is a dispersed phase.

Aspect 17. The composition of any one of aspects 1-16, wherein the synthetic elastomer comprises repeat units of isobutene and a conjugated diene.

Aspect 18. The composition of any one of aspects 1-16, wherein the synthetic elastomer comprises repeat units of isobutene and isoprene.

Aspect 19. The composition of any one of aspects 1-18, wherein the synthetic elastomer is an isoprene-isobutene rubber, a halogenated isoprene-isobutene rubber, or a combination thereof.

Aspect 20. The composition of any one of aspects 1-19, further comprising a curing agent, zinc oxide, an activator, an antidegradant, or a combination thereof,

Aspect 21. A vulcanized rubber composition, comprising the composition of any one of aspects 1-20 that has been vulcanized.

Aspect 22. An article comprising the composition of aspect 21.

Aspect 23. The article of aspect 22, wherein the article comprises a tire or a component of a tire.

Aspect 24. The article of aspect 23, wherein the component of the tire comprises a sealant layer.

Aspect 25. The article of aspect 24, wherein the sealant layer is located on a radially inner surface of the tire.

Aspect 26. The article of aspect 24 or aspect 25, wherein the sealant layer is formed by disposing the composition in an uncured state onto a radially inner surface of the tire and curing the tire at a temperature of less than about 120° C.

Aspect 27. The article of aspect 26, wherein the radially inner surface of the tire is an innerliner of the tire.

From the foregoing, it will be seen that aspects herein are well adapted to attain all the ends and objects hereinabove set forth together with other advantages which are obvious and which are inherent to the structure. While specific elements and steps are discussed in connection to one another, it is understood that any element and/or steps provided herein is contemplated as being combinable with any other elements and/or steps regardless of explicit provision of the same while still being within the scope provided herein.

It will be understood that certain features and subcombinations are of utility and may be employed without reference to other features and subcombinations. This is contemplated by and is within the scope of the claims. The skilled artisan will recognize many variants and adaptations of the aspects described herein. These variants and adaptations are intended to be included in the teachings of this disclosure and to be encompassed by the claims herein.

Now having described the aspects of the present disclosure, in general, the following Examples describe some additional aspects of the present disclosure. While aspects of the present disclosure are described in connection with the following examples and the corresponding text, there is no intent to limit aspects of the present disclosure to this description. On the contrary, the intent is to cover all alternatives, modifications, and equivalents included within the spirit and scope of the present disclosure.

### E. Examples

The following examples are put forth so as to provide those of ordinary skill in the art with a complete disclosure and description of how the compounds, compositions, articles, devices and/or methods claimed herein are made and evaluated and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### 1. Evaluation of Rubber Compositions

Base rubber compositions comprising a butyl rubber and natural rubber are provided in Table 1. The Experimental compositions comprise a two-phase matrix. After curing the composition, the phase comprising a sulfur-reactive polymer (the continuous phase) creates a stable, internal substrate to the sealant. The phase comprising a non-sulfur-reactive polymer (the dispersed phase) has a tacky adhesive nature, allowing it to seal punctures when an object is passed into and out of the material. The continuous phase is made as a masterbatch, and the dispersed phase is then added in a continuous mixing step. After production of a tire (including the cure process), the two-phase mixture is applied to an inner layer of the tire and a secondary cure is done at a lower temperature (e.g., below 120° C.). This low-temperature second cure can prevent modifications to the tire properties during the tire-sealant application process.

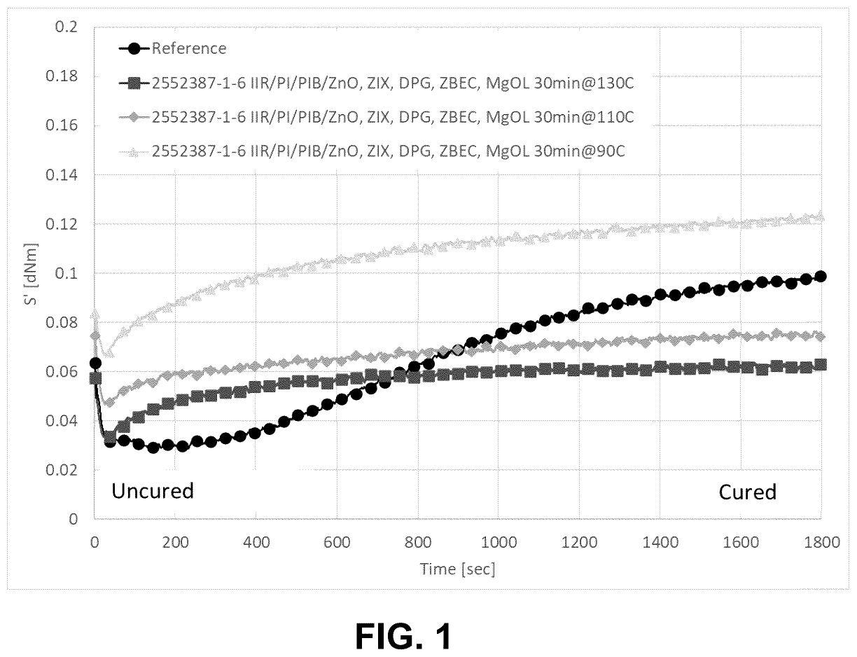

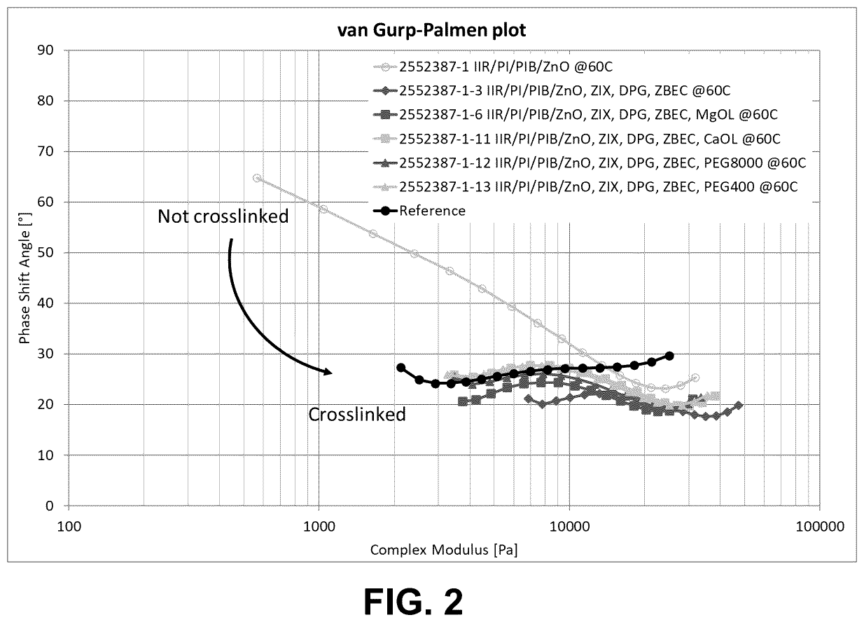

Experimental tire sealant compositions were prepared as discussed above. FIG. 1 shows results from cure testing of Experimental compositions (variations of Base 1 and Base 2 of Table 1) using an Anton Paar moving die rheometer. The cured compositions showed significant crosslinking during cure tests at temperatures below 100° C. In FIG. 2, the experimental tire sealants (variations of Base 1 and Base 2 of Table 1) showed similar rheological behaviors compared to the reference tire sealant. The van Gurp-Palman plot of FIG. 2 illustrates that after cross-linking, the experimental rubber compositions can undergo shear stress without the shear causing deformation or degradation of the composition's physical properties. This means that, under various shear rates, the cross-linked rubber composition retains its viscoelastic properties, allowing it to remain malleable enough so that if a foreign implement (e.g., a nail) punctures the composition then the composition will allow the implement to pass through and will form around or encapsulate the implement.

TABLE 1
Rubber Compositions in phr

| Ingredient | Base 1 | Base 2 |
|---|---|---|
| Butyl Rubber (IIR) | 85 | 85 |
| Polyisoprene (PI) | — | 15 |
| Natural Rubber | 15 | — |
| Diluent¹ | 200 | 225 |
| Processing Additives² | 3 | 3 |
| Carbon Black | 53 | 53 |
| Zinc Isopropylxanthate (ZIX) | 1.5 | 1.5 |
| Co-Accelerator 1³ | 0.65 | 0.65 |
| Co-Accelerator 2⁴ | 0.5 | 0.5 |
| Zinc Oxide (ZNO) | 5 | 5 |
| Sulfur/Curing Agent | 0.7 | 0.7 |
| Total phr | 364.35 | 389.35 |

¹polyisobutene (PIB) or naphthenic oil
²resins such as C5, C7, C9, and/or terpene resins
³guanidine compound
⁴dithiocarbamate compound

It will be apparent to those skilled in the art that various modifications and variations can be made in the present disclosure without departing from the scope or spirit of the disclosure. Other aspects of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

What is claimed is:

1. A composition, comprising at least a first phase and a second phase, wherein:
the first phase comprises from about 10 phr to about 25 phr of a natural rubber, polyisoprene, or a combination thereof;
the second phase comprises from about 75 phr to about 90 phr of a synthetic elastomer; and
both the first phase and the second phase together comprise from about 200 phr to about 500 phr of a diluent.

2. The composition of claim 1, wherein the first phase further comprises from about 1 phr to about 8 phr of a first resin.

3. The composition of claim 2, wherein the first resin is a hydrocarbon resin selected from the group consisting of C5 aliphatic resins, C9 aromatic resins, C7 epoxy resins, terpene resins, and a combination thereof.

4. The composition of claim 1, wherein the second phase further comprises from about 1 phr to about 8 phr of a second resin.

5. The composition of claim 4, wherein the second resin is a hydrocarbon resin selected from C5 aliphatic resins, C9 aromatic resins, C7 epoxy resins, terpene resins, and a combination thereof.

6. The composition of claim 1, wherein the diluent is selected from a polyisobutene, a naphthenic oil, or a combination thereof.

7. The composition of claim 1, wherein both the first phase and the second phase together further comprise an accelerator.

8. The composition of claim 7, wherein the accelerator comprises zinc isopropylxanthate.

9. The composition of claim 8, wherein the accelerator comprises from about 1 phr to about 3 phr of zinc isopropylxanthate.

10. The composition of claim 8, wherein the composition further comprises an additional accelerator selected from the group consisting of an amine, an imine, a sulfenamide, a guanidine, a dithiocarbamate, a thiadiazole, a thiazole, a thiourea, a thiuram, a dithiophosphate, a xanthate, and a combination thereof.

11. The composition of claim 8, wherein the composition further comprises an additional accelerator selected from the group consisting of cyclohexylethylamine; hexamethylene tetramine; ethyldiene aniline; butyraldehyde dianiline condensate; N-cyclohexyl-2-benzothiazolesulfenamide; N-tertbutyl-2-benzothiazolesulfenamide; N,N-dicyclohexyl-2-benzothiazolesulfenamide; 2-(2-4′dinitrophenylmercapto) benzothiazole; diphenylguanidine; 1,3-di-o-tolylguanidine; triphenylguanidine; Zinc diethyl dithiocarbamate; zinc N-dibutyl dithiocarbamate; zinc N-ethyl-N-phenyl dithiocarbamate; zinc dibenzyldithiocarbamate; N-cyclohexyl-S-(1,3,4-thiadiazol-2-yl)thiohydroxylamine; 2-mercaptobenzothiazole; 2,2′-dithiobenzothiazole; zinc 2-mercaptobenzothiazole; 2-(morpholinothio) benzothiazole; ethylenethiourea; N—N′-diphenylthiourea; tetramethylthiuram disulfide; tetraethylthiuram disulfide; tetramethylthiuram monosulfide; dipentamethylenethiuram tetrasulfide; zinc dithiophosphate; zinc butylxanthate; sodium isopropyl xanthate; and a combination thereof.

12. The composition of claim 1, wherein the synthetic elastomer comprises repeat units of isobutene and a conjugated diene.

13. The composition of claim 1, further comprising a curing agent, zinc oxide, an activator, an antidegradant, or a combination thereof.

14. A vulcanized rubber composition, comprising the composition of claim 1 that has been vulcanized.

15. An article comprising the composition of claim 14.

16. The article of claim 15, wherein the article comprises a tire or a component of a tire.

17. The article of claim 16, wherein the component of the tire comprises a sealant layer.

18. The article of claim 17, wherein the sealant layer is located on a radially inner surface of the tire.

19. The article of claim 17, wherein the sealant layer is formed by disposing the composition in an uncured state onto a radially inner surface of the tire and curing the tire at a temperature of less than about 120° C.

20. The article of claim 19, wherein the radially inner surface of the tire is an innerliner of the tire.
